(19) United States
(12) Patent Application Publication
(10) Pub. No.: US 2009/0154761 A1
(43) Pub. Date: Jun. 18, 2009

(54) Image display method and image display system using the same

(75) Inventors: Ji-hyun Goh, Changwon-city (KR); Sung-cheol Bae, Changwon-city (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Techwin Co., Ltd., Changwon-city (KR)

(21) Appl. No.: 12/218,408

(22) Filed: Jul. 15, 2008

(30) Foreign Application Priority Data
Dec. 14, 2007 (KR) 10-2007-0131047

(51) Int. Cl. G06K 9/00

(52) U.S. Cl. 382/100

(57) ABSTRACT

An image display method and an image display system using the method. In the method, location information is extracted from each of a plurality of image files, and map information corresponding to the location information is extracted. Then, images contained in the image files and the map information are displayed. The map information includes map images of places corresponding to the location information. In addition, a representative map image, which is determined based on a distance between the images contained in the image files and by using the map images, is displayed.

### CROSS-REFERENCE TO RELATED PATENT APPLICATION

This application claims the priority of Korean Patent Application No. 10-2007-0131047, filed on Dec. 14, 2007, in the Korean Intellectual Property Office, the entire contents of which is incorporated herein by reference.

### BACKGROUND OF THE INVENTION

1. Field of the Invention

The present invention relates to an image display method, in which images in image files are edited or reconfigured and then displayed accordingly, and an image display system using the image display method.

2. Description of the Related Art

With the introduction of electronic albums, it is now possible to display images, which were captured using a digital photographing device, on a digital device and view the displayed images without developing the images. However, when viewing the displayed images, users often cannot remember where the images were captured. In particular, when the images were captured a long time ago, or when too many images are displayed, it is very difficult to remember where each of the images was captured.

### SUMMARY OF THE INVENTION

The present invention provides an image display method which enables a user to easily obtain information regarding locations, which indicate where images were captured, when viewing the images displayed on a digital device or viewing printed versions of the images, and an image display system using the image display method.

Accordingly, an embodiment of the present invention provides an image display method comprising the steps of providing a plurality of image files including location information, extracting the location information from each of the image files, extracting map information corresponding to the location information, and displaying images in the image files and the map information. The map information includes map images of places corresponding to the location information, and a representative map image, which is determined based on a distance between the images contained in the image files and by using the map images, is displayed.

The method may further include printing the displayed images and the displayed map information. The location information may include latitudes, longitudes, or altitudes of locations where the images contained in the image files were captured. The map information may further include the address of each of the places, the name of the place, directions to the place, or a combination of two or more of these. Also, the information can be digitized and represent as codes.

The method may further include calculating the distance between the images in the image files. The distance denotes the distance between the locations where the images contained in the image files were captured. The distance may be calculated using location information of the locations.

The method may further include determining whether the distance between the images contained in the image files is greater than a predetermined reference value. When the distance between the images contained in the image files is greater than the predetermined reference value, a first representative map image, which includes at least a part of each map image, may be generated. When the distance between the images contained in the image files is not greater than the reference value, any one of the map images from among corresponding to the images contained in the image files may be selected as a second representative map image and displayed. Alternatively, a map image configured based on at least one of the locations, which indicate where the images contained in the image files were captured, may be generated, and the generated map image may be determined as the second representative map image. For example, the generated map image may be configured to have at least one of the locations, which indicate where the images contained in the image files were captured, at the center thereof.

The reference value may be set to a distance corresponding to a diagonal length of the map images. The reference value may be set to a distance which corresponds to a diagonal length of the map images and which is calculated in consideration of a scale.

If the distance between the map images is greater than the distance corresponding to the diagonal length of the map images, the locations where the images contained in the image files were captured cannot be shown together in any one of the map images unless the scale of the map images is changed. Thus, the first representative map image including the at least a part of each map image may be generated and displayed.

If the distance between the map images is not greater than the distance corresponding to the diagonal length of the map images, that is, the reference value, any one of the map images may be selected as the second representative map image. Alternatively, a map image may be configured based on at least one of the locations, which indicate where the images contained in the image files were captured, and determined as the second representative map image. Since the second representative map image shows all of the locations where the images contained in the image files were captured, overlapping map images can be prevented from being displayed.

In addition, the method may further include determining whether the distance between the images contained in the image files is greater than a predetermined reference value. When the distance between the images contained in the image files is greater than the reference value, a third representative map image having a scale, which was changed from that of the map images to make the distance between the images contained in the image files not greater than the reference value, may be generated. When the distance between the images contained in the image files is not greater than the reference value, any one of the map images from among corresponding to the images contained in the image files may be selected as a fourth representative map image and displayed. Alternatively, a map image configured based on at least one of the locations, which indicate where the images contained in the image files were captured, may be generated. Then, the generated map image may be determined as the fourth representative map image and displayed.

The third representative map image has a different scale from that of the map images corresponding to the location information of the image files. That is, the third representative map image has a reduced scale from that of the map images in order to show all of the locations where the images contained in the image files were captured. Due to the reduced scale, the third representative map image is less detailed than the map images. That is, even when the distance between the images in the image files is greater than the reference value, the third representative map image, which has a reduced scale and is thus less detailed, can be generated to show all of the locations where the images contained in the image files were captured.

The fourth representative map image may be generated in the same way as the second representative map image. That is, any one of the map images, which correspond to the location information of the image files, may be selected as the fourth representative map image. Alternatively, a map image configured based on at least one of the locations, which indicate where the images contained in the image files were captured, may be generated and determined as the fourth representative map image. The fourth representative map image may show all of the locations where the images contained in the image files were captured.

The method may further include displaying an icon at each location, which indicates where the image in each of the image files was captured, in the representative map image. In particular, the icon may represent an arrangement of an image contained in a corresponding image file on a screen. When the arrangement of the image in the corresponding image file is changed, the icon may represent the changed arrangement of the image on the screen.

Another embodiment of the present invention provides an image display method comprising providing a plurality of image files including location information, extracting the location information from each of the image files, extracting map information corresponding to the location information, and displaying images contained in the image files, the map information and an icon at each location. The map information comprises map images of places corresponding to the location information, and a representative map image is displayed which is determined based on a distance between the images contained in the image files and by using the map images. The icon indicates where the image in each of the image files was captured, in the representative map image. Also, the icon represents the arrangement of an image contained in a corresponding image file on a screen.

Another embodiment of the present invention provides an image display system including a management server which includes a location information extracting unit which extracts location information from each of a plurality of image files, a map information extracting unit which extracts map information including map images corresponding to the extracted location information, and a representative map image determining unit which determines a representative map image using the map images from among which correspond to images contained in the image files. The image display system further includes a terminal which displays the representative map image provided by the management server and the images in the image files.

The management server may further include a map information storage unit which stores the map information. Therefore, the map information extracting unit may extract the map information corresponding to the location information from the map information storage unit. The system may further include a map information providing server which receives the location information from the management server and provides the map information corresponding to the location information.

The representative map image determining unit may include a determination unit which determines whether the distance between the images contained in the image files is greater than a predetermined reference value. The representative map image determining unit may further include a generating unit which generates a first representative map image including at least a part of each map image when the determination unit determines that the distance between the images contained in the image files is greater than the reference value, and which selects any one of the map images as a second representative map image or generates a map image configured based on at least one of locations, which indicate where the images contained in the image files were captured, and determines the generated map image as the second representative map image when the distance between the images contained in the image files is not greater than the reference value.

Alternatively, the representative map image determining unit may include a determination unit which determines whether the distance between the images contained in the image files is greater than a predetermined reference value, and a generating unit. In this arrangement, the generating unit generates a third representative map image having a scale that is changed from that of the map images to make the distance between the images contained in the image files not greater than the reference value when the distance between the images contained in the image files is greater than the reference value and which selects any one of the map images as a fourth representative map image or generates a map image configured based on at least one of the locations, which indicate where the images contained in the image files were captured, and determines the generated map image as the fourth representative map image when the distance between the images contained in the image files is not greater than the reference value.

The management server may further include an icon generating unit which generates an icon representing the arrangement of an image contained in a corresponding image file on a screen, and the terminal may display the icon in the representative map image. The system may print the representative map image and the images contained in the image files which are displayed on the terminal. The terminal may be a printer which includes a printing unit. Alternatively, the system may further include a printer separated from the terminal and connected to the terminal in order to print the representative map image and the images contained in the image files which are displayed on the terminal.

### BRIEF DESCRIPTION OF THE DRAWINGS

The above and other features and advantages of the present invention will become more apparent by describing in detail exemplary embodiments thereof with reference to the attached drawings in which:

FIG. 1 is a diagram for explaining an example of a network of an image display system according to an embodiment of the present invention;

FIG. 2 is a block diagram of an example of a management server included in the image display system of FIG. 1;

FIG. 3 is a block diagram of an example of a map information providing server included in the image display system of FIG. 1;

FIG. 4 is a block diagram of an example of a terminal included in the image display system of FIG. 1;

FIG. 5 is a flowchart illustrating an example of an image display method according to an embodiment of the present invention;

FIGS. 6 through 8 show a screen displaying examples of images and map information according to the image display method of FIG. 5;

FIG. 9 is a flowchart illustrating an example of a method of displaying map information according to an embodiment of the present invention, wherein the method is included in the image display method of FIG. 5;

FIGS. 10 and 11 show an example of a screen displaying map information according to the method of FIG. 9;

FIG. 12 is a flowchart illustrating an example of a method of displaying map information according to another embodiment of the present invention, wherein the method is included in the image display method of FIG. 5;

FIGS. 13 shows a screen displaying an example of map information according to the method of FIG. 12; and

FIGS. 14 through 16 show a screen displaying examples of images and map images according to the image display method of FIG. 5, wherein icons according to various embodiments of the present invention are placed at locations, which indicate where the images were captured, in the map images.

### DETAILED DESCRIPTION OF THE EMBODIMENTS

Exemplary embodiments of the present invention will now be described more fully with reference to the accompanying drawings. The invention may, however, be embodied in many different forms and should not be construed as being limited to the embodiments set forth herein.

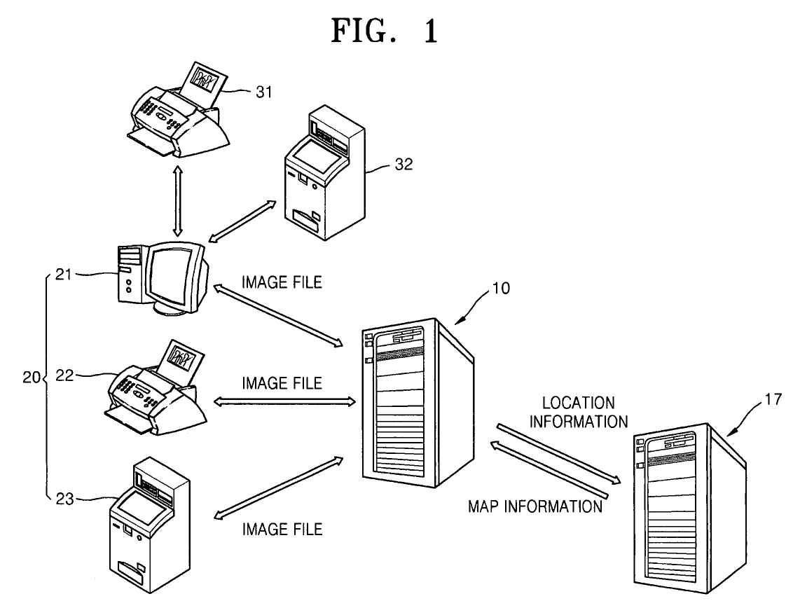

FIG. 1 is a diagram for explaining an example of a network of an image display system according to an embodiment of the present invention.

As shown in FIG. 1, a terminal 20, such as a personal computer (PC) 21, a printer 22 or a kiosk 23, is connected to a management server 10, and the management server 10 is connected to a map information providing server 17 which provides map information. The management server 10 may be an apparatus on which a program for editing a plurality of image files transmitted from the terminal 20 and for configuring an electronic album is recorded. The map information providing server 17 may be an apparatus on which a map program is recorded.

The management server 10 receives a plurality of image files from the terminal 20, extracts location information from each image file, and transmits the extracted location information to the map information providing server 17. Then, the management server 10 receives map information (containing map images), which corresponds to the location information, from the map information providing server 17. The management server 10 determines a representative map image by using the received map images and based on the distance between images contained in the image files, and transmits the representative map image to the terminal 20, so that the terminal 20 can display the representative map image and the images of the image files. As used herein, the distance between images contained in image files denotes the distance between locations where the images were captured.

In the image display system according to this embodiment, the map information providing server 17 and the management server 10 are implemented as separate apparatuses. However, the present invention is not limited to this arrangement. That is, the map information providing server 17 and the management server 10 may be integrated into a single apparatus.

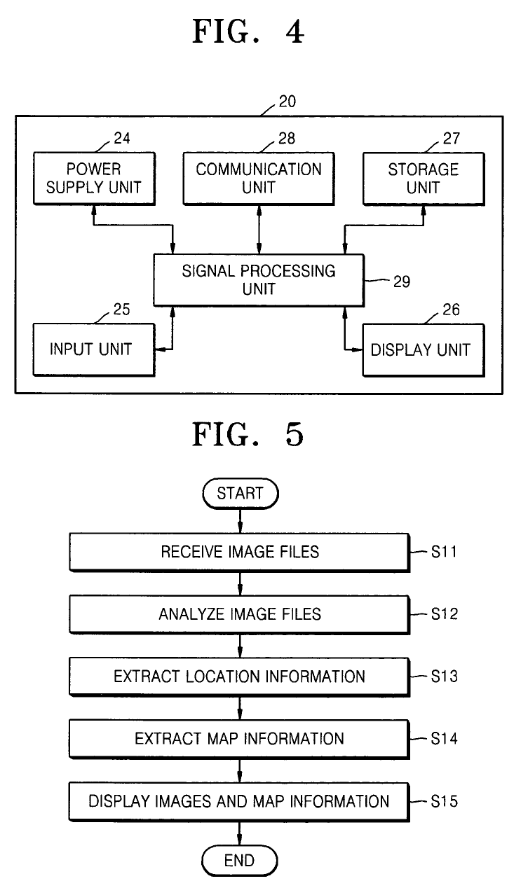

The terminal 20 of the image display system according to this embodiment may be the printer 22 or the kiosk 23 which includes a printing unit. In this case, the printing unit may print a representative map image and images of image files which are displayed on the terminal 20. Alternatively, the image display system according to this embodiment may further include a printer 31 or a kiosk 32 which is separated from the terminal 20 and connected to the terminal 20, so that a screen image displayed on a display unit 26 (see FIG. 4) of the terminal 20 can be printed by the printer 31 or the kiosk 32. That is, if the terminal 20 is the PC 21, the printer 31 or the kiosk 32 may be connected to the terminal 20.

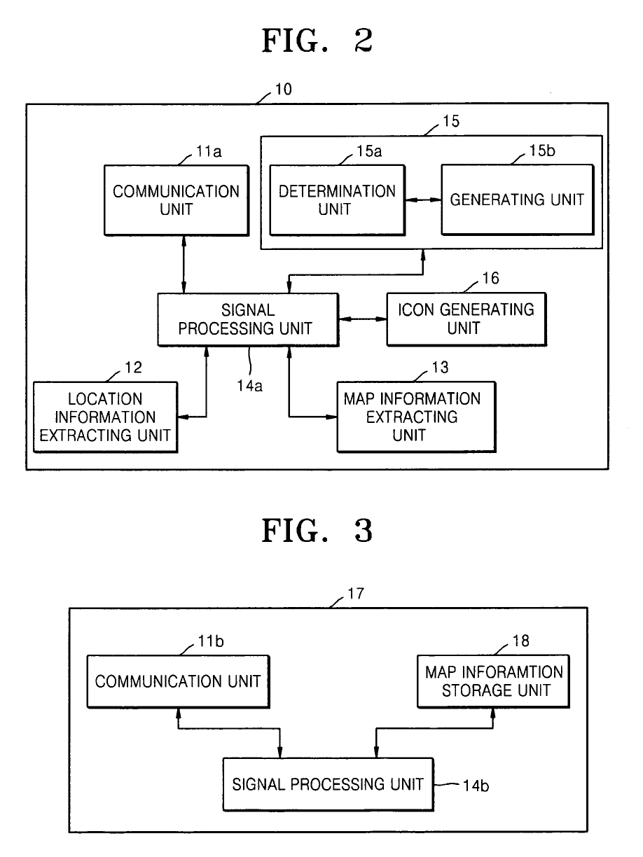

FIG. 2 is a block diagram of and example of the management server 10 included in the image display system of FIG. 1. As shown in FIG. 2, the management server 10 includes a communication unit 11a, location information extracting unit 12, a map information extracting unit 13, and a signal processing unit 14a. If the terminal 20 or the map information providing server 17 is separated from the management server 10, the communication unit 11a exchanges image files, location information, map information and the like with the terminal 20 or the map information providing server 17.

The location information extracting unit 12 extracts location information from each image file received from the terminal 20. The location information includes the latitude, longitude, altitude of a location where an image in each image file was captured and is contained in Exif which is a header portion of each image file. When capturing the image, a photographing apparatus may generate the location information using a location information sensor included therein. Then, the photographing apparatus may generate an image file which includes the generated location information as well as the captured image. Alternatively, after the photographing operation, the photographing apparatus may input the location information to the terminal 20, so that the terminal 20 can insert the location information into the image file.

The map information extracting unit 13 extracts map information which corresponds to the location information extracted by the location information extracting unit 12. The map information includes a map image of a place which corresponds to the extracted location information. In addition, the map information may include the address of the place, the name of the place, directions to the place, or a combination of two or more of the same. A database of the map information corresponding to the location information, that is, a map information storage unit, may be included in the management server 10 or included in the map information providing server 17, which will be described later with reference to FIG. 3, as a separate apparatus. The signal processing unit 14a processes a signal used to control each element of the management server 10, so that the management server 10 performs a desired operation.

The management server 10 may further include elements that a conventional server generally has. That is, the management server 10 may further include, for example, a power supply unit which supplies power, an input unit to which external signals are input, and a storage unit which stores operating programs of the management server 10. In addition, the management server 10 may further include a representative map image determining unit 15 or an icon generating unit 16.

Specifically, the representative map image determining unit 15 determines a representative map image by using a plurality of map images. The map images corresponding to location information of each image in the image files are extracted in plural numbers. Then, the representative map image determining unit 15 generates a single representative map image by using the plural number of map images, and displays the representative map image on the terminal 20.

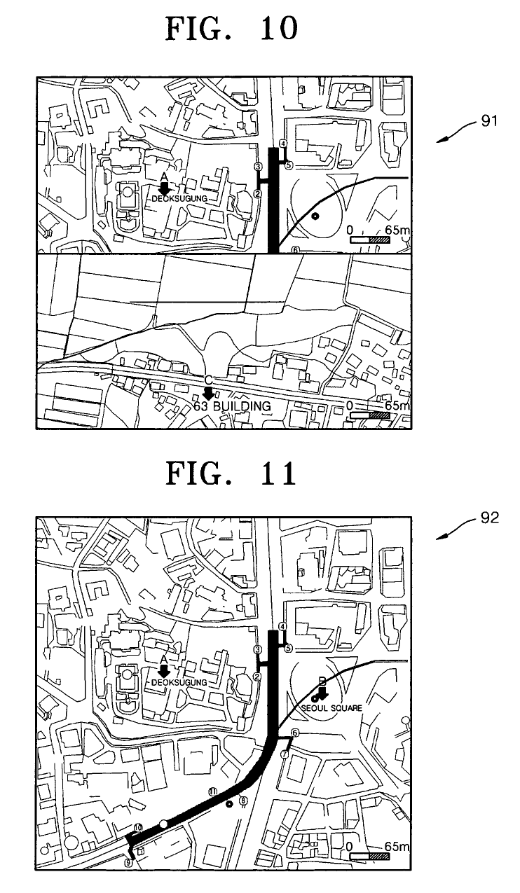

According to an embodiment of the present invention, the representative map image determining unit 15 may include a determination unit 15a and a generating unit 15b. The determination unit 15a determines whether the distance between the images of the image files is greater than a reference value. When the determination unit 15a determines that the distance is greater than the reference value, the generating unit 15b generates a first representative map image. The first representative map image includes at least a part of each map image. Preferably, the first representative map image includes portions corresponding to each location where image is captured, which indicate where the map images were captured. When the determination unit 15a determines that the distance is not greater than the reference value, the generating unit 15b selects any one of the map images from among corresponding respectively to the images contained in the image files as a second representative map image. Alternatively, the generating unit 15b generates a map image configured based on at least one of locations, which indicate where the images contained in the image files were captured, in the map images and determines the generated map image as the second representative map image. An example of the first representative map image is shown in FIG. 10, and an example of the second representative map image is shown in FIG. 11.

As mentioned above, the distance between the images contained in the image files denotes the distance between the locations where the images contained in the image files were captured. Therefore, the distance between the images can be calculated using location information of each map image. For example, the difference between the latitudes of the images contained in the image files is calculated. Since a difference of one degree in latitude corresponds to approximately 111.1 km, if the calculated approximate difference is multiplied by 111.1 km, the distance between the images of the image files in directions toward North and South poles of the earth can be obtained. The difference between the longitudes of the images contained in the image files may be calculated in the same way as the difference between the latitudes of the images contained in the image files is calculated. By using the calculated differences in the latitudes and longitudes of the images in the image files, the distance between the map images can be calculated. In addition, the three-dimensional (3D) distance between the map images can be calculated using the difference between the altitudes of the images in the image files.

The reference value may be set to a distance in which all of the locations, which indicate where the images contained in the image files were captured, can be shown together in any one of the map images corresponding to the location information of the image files, respectively. For example, the reference value may be set to a distance which corresponds to a diagonal length of the map images.

The first representative map image includes reduced or clipped versions of the map images. Each map image included in the first representative map image shows an icon indicating a location where an image contained in a corresponding image file was captured.

The second representative map image is a map image selected from the map images, or a map image configured based on at least one of the locations, which indicate where the images contained in the image files were captured, in the map images. The second representative map image may show a plurality of icons indicating the locations where the images contained in the image files were captured.

According to another embodiment of the present invention, the representative map image determining unit 15 may include a determination unit 15a and a generating unit 15b. The determination unit 15a determines whether the distance between the images of the image files is greater than the reference value. When the determination unit 15a determines that the distance is greater than the reference value, the generating unit 15b generates a third representative map image having a scale which was changed from that of the map images to make the distance not greater than the reference value. When the determination unit 15a determines that the distance is not greater than the reference value, the generating unit 15b selects any one of the map images as a fourth representative map image. Alternatively, the generating unit 15b generates a map image configured based on at least one of locations, which indicate where the images contained in the image files were captured, in the map images and determines the generated map image as the fourth representative map image.

An example of the third representative map image is shown in FIG. 13. Since the fourth representative map image is identical to the second representative map image, an example thereof is as shown in FIG. 11.

The third representative map image is a map image having a different scale from the map images. That is, the third representative map image has a reduced scale from that of the map images in order to show all of the location information of the images in the image files. Since the third representative map image has the reduced scale, it is less detailed than the map images. The third representative map image may show a plurality of icons indicating the locations where the images contained in the image files were captured.

The fourth representative map image has the same scale as the map images. The fourth representative map image is a map image selected from the map images, or a map image configured based on at least one of the locations, which indicate where the images contained in the image files were captured, in the map images. The fourth representative map image is generated in the same way as the representative map image determining unit 15 generates the second representative map image as discussed above.

The management server 10 further includes the icon generating unit 16 which generates an icon indicating where on the screen of the terminal 20 the image in each image file is placed. Therefore, when a map image corresponding to location information of an image in an image file is displayed on the terminal 20, the generated icon may be placed on the map image.

FIG. 3 is a block diagram of an example of the map information providing server 17 included in the image display system of FIG. 1. As shown in FIG. 3, the map information providing serve 17 includes a map information storage unit 18, a communication unit 11b, and a signal processing unit 14b.

The map information storage unit 18 stores a database of map information which corresponds to location information included in each image file. The map information may include a map image of a place where an image in each image file was captured, the address of the place, the name of the place, and directions to the place. The communication unit 11b receives the location information of each image file from the management server 10 and transmits map information, which corresponds to the received location information, to the management server 10. The signal processing unit 14b processes a signal used to control each element of the map information providing server 17 in order to operate the map information providing server 17.

In this embodiment, the map information providing server 17 is implemented as a separate apparatus. However, the map information providing server 17 may also be included in the management server 10 of FIG. 2. That is, if the management server 10 further includes the map information storage unit 18 and if the communication unit 11b and the signal processing unit 14b are shared with the management server 10, the map information providing server 17 and the management server 10 can be integrated into a single apparatus the map information providing server 17 can be integrated into the management server 10.

The map information providing server 17 may further include elements that a conventional server generally has. That is, the map information providing server 17 may further include, for example, a power supply unit which supplies power, an input unit to which external signals are input, and a storage unit which stores operating programs of the map information providing server 17.

FIG. 4 is a block diagram of an example of the terminal 20 included in the image display system of FIG. 1. In this embodiment, the terminal 20 transmits a plurality of image files, which contain location information, to the management server 10 and displays images contained in the image files and map information which is received from the management server 10. The terminal 20 may be any apparatus which can perform these functions, such as a PC, a printer, a kiosk, a cellular phone, or a personal digital assistant (PDA).

As shown in FIG. 4, the terminal 20 includes a power supply unit 24, an input unit, the display unit 26, a storage unit 27, a communication unit 28, and a signal processing unit 29. The power supply unit 24 supplies power to the terminal 20 to drive the terminal 20. The power supply unit 24 may include batteries therein or may be an interface connected to an external power source in order to be provided with power from the external power source.

A signal generated by an external source, for example, a user, is input to the input unit 25. The input unit 25 may be a keyboard, a remote control, a group of control buttons, a touch pad, or a touch screen. The display unit 26 displays images contained in a plurality of image files and a representative map image which is received from the management server 10. The display unit 26 may be a liquid crystal display (LCD), an organic light-emitting diode (OLED), or an electrodeposition display (EDD). The storage unit 27 stores programs for operating the terminal 20. In addition, the storage unit 27 may temporarily store image data included in the image files or store the image files. The signal processing unit 29 processes a signal used to control each element of the terminal 20.

The terminal 20 may further include a printing unit to perform a printing operation. For example, if the terminal 20 is a printer or a kiosk, the printing unit may print the images of the image files and the representative map image which are displayed on the display unit 26 of the terminal 20. However, the present invention is not limited to this arrangement. The image display system according to the present embodiment may further include a printer which is connected to the terminal 20 and implemented outside the terminal 20, so that a screen image displayed on the display unit 26 of the terminal 20 can be printed by the printer. That is, if the terminal 20 is a PC, the printer may be connected to the terminal 20.

FIG. 5 is a flowchart illustrating an example of an image display method according to an embodiment of the present invention. As shown in FIG. 5, a plurality of image files are received in operation S11. Then, the image files are analysed in operation S12. Next, location information is extracted from each of the image files in operation S13. The location information refers to information regarding a location where an image in each image file was captured. The location information may include, for example, the latitude, longitude, and altitude of the location.

Map information corresponding to the extracted location information is extracted in operation S14. The map information may be extracted from a database in which the map information corresponding to the location information is pre-stored. The map information includes a map image of a location where the image in each image file was captured. In addition, the map information may include the address of a place at the location, the name of the place, and directions to the place.

The images contained in the image files and the map information, which corresponds to the location information of the images, are displayed together in operation S15. In this case, the map information includes map images and a representative map image which is determined based on the distance between the images in the image files. That is, the images contained in the image files and the representative map image are displayed together. Therefore, while viewing the images, a user can identify the locations, which indicate where the images were captured, and thus can easily obtain information about the locations.

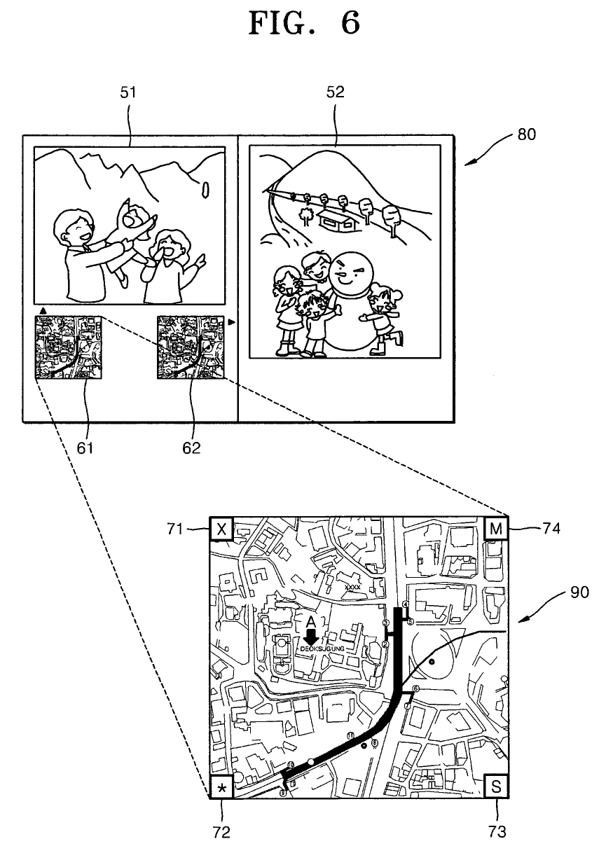

FIGS. 6 through 8 show example of a screen displaying images and map information according to the image display method of FIG. 5. In this case, the screen is part of the display unit 26 of the terminal 20. That is, the screen is a surface of the display unit 26 on which images in image files are displayed, so that a user can view the displayed images. The screen displays images and map information received from the management server 10 which provides an electronic album. Specifically, the screen displays a layout provided by the management server 10 and a page of an electronic album in which images are contained are inserted into the layout.

Referring to FIG. 6, a first image 51 and a second image 52 sized according to the layout are displayed on a main window 80 of the screen of the display unit 26 included in the terminal 20. In addition, a first map image 61 and a second map image 62 are displayed in the remaining space of the main window 80. In this case, the first map image 61 corresponds to information regarding a location where the first image 51 was captured, and the second map image 62 corresponds to information regarding a location where the second image 52 was captured.

The first map image 61 shows an icon ‘A’ at the location where the first image 51 was captured, and the second map image 62 shows an icon ‘B’ at the location where the second image 52 was captured. The first map image 61 is displayed under the first image 51, and the second map image 62 is displayed on the left side of the second image 52.

A user may arbitrarily determine where on the screen the first and second images 51 and 52 and the first and second map images 61 and 62 are to be displayed. Alternatively, the arrangements of the first and second images 51 and 52 and the first and second map images 61 and 62 on the screen may be arbitrarily determined by a program which is pre-stored in an electronic album managing server 10 that manages the electronic album.

If the first map image 61 is enlarged and displayed on a sub window 90, ‘Deoksugung,’ which is the name of a place at the location where the first image 51 was captured, can be seen under the icon ‘A’ in the first map image 61. An icon ‘X’ 71 for closing the sub window 90 is displayed at an upper left corner of the first map image 61. An icon ‘M’ 74 for selecting the first map image 61 to generate a representative map image with another selected map image is displayed at an upper right corner of the first map image 61. In addition, an icon ‘*’ 72 is displayed at a lower left corner of the first map image 61. The icon ‘*’ 72 is used to move the first map image 61 in order to display a map image of a place other than the place currently shown on the sub window 90. An icon ‘S’ 73 for reducing or enlarging the first map image 61 is displayed at a lower right corner of the first map image 61.

When the user views the above icons 71 through 73 provided on the sub window 90 of the display unit 26 included in the terminal 20 and selects any one of the icons 71 through 73 by using the input unit 25 of the terminal 20, a function corresponding to the selected icon is performed.

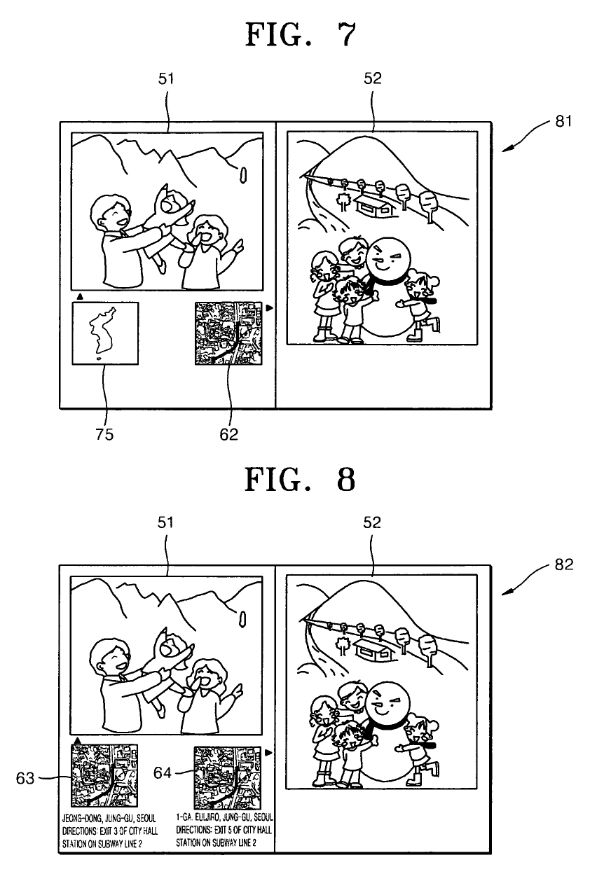

Unlike FIG. 6 in which the first map image 61 is shown (see FIG. 6) displayed on the main window 80, FIG. 7 shows an example of an icon 75 displayed on a main window 81, wherein the icon 75 indicates the presence of the first map image 61 corresponding to the first image 51. Therefore, when the icon 75 is selected, the first map image 61 may be displayed. Here, the first map image 61 (see FIG. 6) may be displayed together with the second map image 62 on the main window or may be displayed on a separate sub window.

FIG. 8 shows an example of a main window 82 on which first map information 63 corresponding to the location where the first image 51 was captured is displayed. In this case, the first map information 63 includes the first map image 61, the address of the location where the first image 51 was captured, and directions to the location. The location where the first image 51 was captured is ‘Jeong-dong, Jung-gu, Seoul,’ and the directions to the location are ‘Exit 3 of City Hall Station on Subway Line 2.’ Second map information 64, which includes the second map image 62 of the location where the second image 52 was captured, the address of the location, and directions to the location, is also displayed on the main window 80. The address of the location where the second image 52 was captured is ‘1-ga, Eulji-ro, Jung-gu, Seoul,’ and the directions to the location are ‘Exit 5 of City Hall Station on Subway Line 2.’

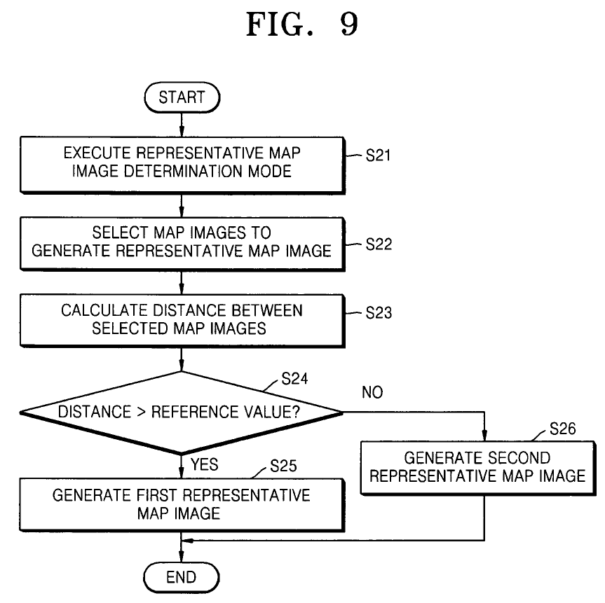

FIG. 9 is a flowchart illustrating an example of a method of displaying a plurality of images and map images corresponding to the images according to an embodiment of the present invention, wherein the method is included in the image display method of FIG. 5. In the present embodiment, a method of determining a representative map image by using the map images and displaying the representative map image will be described.

Referring to FIG. 9, when a representative map image determination mode is executed in operation S21, map images to generate the representative map image are selected in operation S22. For example, when the icon ‘M’ 74 is selected on the sub window 90 shown in FIG. 6, the first map image 61 is selected as a map image for generating the representative map image.

Two or more map images are selected, and the distance between the selected map images is calculated in operation S23. The distance between the selected map images refers to the distance between locations where the images in corresponding image files were captured and can be calculated using location information.

It is determined whether the calculated distance between the map images is greater than a predetermined reference value in operation S24. In this case, the reference value may be set to a distance in which all of the locations, which indicate where the images contained in the image files were captured, can be shown together in one map image. If it is determined that the calculated distance is greater than the reference value, a first representative map image containing the map images is generated in operation S25.

Specifically, a first representative map image 91 is shown in FIG. 10 as an example. A first map image corresponding to location information of a first image file and the name of a location, which indicates where an image corresponding to the location information was captured, that is, ‘Deoksugung,’ are extracted as map information. In the first map image, the location where the image in the first image file was captured, that is, ‘Deoksugung,’ is marked with a character ‘A’. In addition, a third map image corresponding to location information of a third image file and the name of a location, which indicates where an image corresponding to the location information was captured, that is, ‘63 Building,’ are extracted as map information. In the third map image, the location where the image in the third image file was captured, that is, ‘63 Building,’ is marked with a character ‘C’. The first map image and the third map image are selected. Then, the distance between the first map image and the third map image is calculated. The actual distance between ‘Deoksugung’ and ‘63 Building’ is the distance between the first map image and the third map image. Here, the distance between the first map image and the third map image can be calculated using the location information included in the respective image files, such as latitude, longitude or altitude. The calculated distance between the first map image and the third map image, that is, between ‘Deoksugung’ and ‘63 Building,’ is at or about 6158 m. If the reference value indicating the distance in which the above locations can be shown together in one map image is at or about 1000 m, the distance between the first map image and the third map image is greater than the reference value. Thus, the first representative map image 91 including both the first map image and the third map image is generated.

The first representative map image 91 of FIG. 10 includes an upper map image, which was reduced or clipped from the first map image based on ‘Deoksugung,’ and a lower map image which was reduced or clipped from the third map image based on ‘63 Building.’ Referring back to FIG. 9, if it is determined that the calculated distance is not greater than the reference value, any one of the map images is selected as a second representative map image. Alternatively, a map image is configured based on at least one of the locations, which indicate where the images contained in the image files were captured, in the map images and determined as the second representative map image in operation S26.

Referring to FIG. 11, a second representative map image 92 is shown as an example. When the distance between a first map image showing a location where an image in a first image file was captured and a second map image showing a location where an image in a second image file was captured is not greater than a predetermined reference value, any one of the first map image and the second map image is selected. In this embodiment, any one of the first map image and the second map image is selected as the second representative map image 92. However, the present invention is not limited to this arrangement. A map image, which has any one of the location in the first map image and the location in the second map image at its center, may be generated and determined as the second representative map image 92.

If the location in the first map image is ‘Deoksugung’ and the location in the second map image is ‘Seoul Square,’ the distance between the first map image and the second map image is at or about 284 m. If the reference value indicating the distance in which the above locations can be shown together in one map image is at or about 1000 m, the distance between the first map image and the second map image is not greater than the reference value. Therefore, any one of the first map image and the second map image may be selected as the second representative map image 92. Alternatively, a map image may be configured based on any one of the locations, which indicate where the images in the first and second image files were captured, in the first and second map images and determined as the second representative map image 92. Then, in the second representative map image 92, the location where the image in the first image file was captured is marked with an icon ‘A’ and ‘Deoksugung’ which is the name of the location. In addition, the location where the image in the second image file was captured is marked with an icon ‘B’ and ‘Seoul Square’ which is the name of the location.

When images in a plurality of image files are displayed together, map images corresponding to the images may be displayed as one representative map image. Therefore, a user can easily identify the locations where the images were captured.

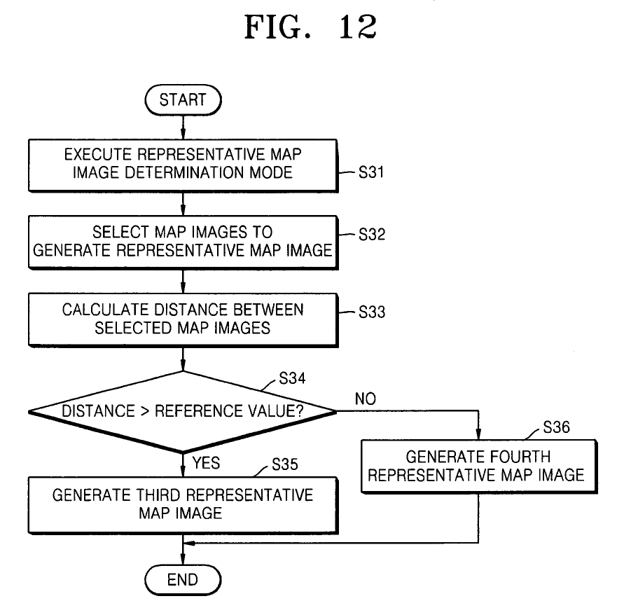

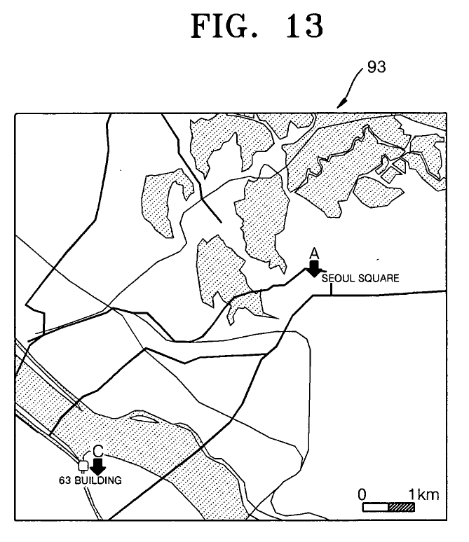

FIG. 12 is a flowchart illustrating an example of a method of displaying map information according to another embodiment of the present invention, wherein the method is included in the image display method of FIG. 5. As shown in FIG. 12, as in the method of FIG. 9, the representative map image determination mode is executed in operation S31, and map images to generate a representative map image are selected in operation S32. Then, the distance between the selected map images is calculated in operation S33. Next, it is determined whether the distance between the map images is greater than a predetermined reference value in operation S34. Unlike in FIG. 9, if it is determined that the distance is greater than the reference value, a third representative map image having a scale which was changed from that of the map images to make the distance not greater than the reference value, is generated in operation S35.

Specifically, a third representative image 93 is shown in FIG. 13 as an example. As described above with reference to FIG. 10, the first map image, which shows ‘Deoksugung’ and has a scale of 1 cm:65 m, is obtained. In addition, the third map image, which shows ‘63 Building’ and has the same scale as the first map image, is obtained. Then, the distance between the first map image and the third map image is calculated. The actual distance between ‘Deoksugung’ and ‘63 Building,’ is at or about 6158 m. If the reference value indicating the distance in which the above locations can be shown together in one map image is at or about 1000 m, the distance between the first map image and the third map image is greater than the reference value. Thus, the third representative map image 93 is generated. That is, when it is not possible to show ‘Deoksugung’ and ‘63 Building’ together in one map image having a scale of 1 cm:65 m, the third representative map image 93 having a reduced scale from the scale of 1 cm:65 m is generated. As shown at the lower right corner of the third representative map image 93, the third representative map image 93 has a scale of 1 cm:1 km. The third representative map image 93 is not greater detailed than the first map image, the second map image, and the second representative map image 92 shown in FIG. 11.

Referring back to FIG. 12, if it is determined that the distance between the map images is not greater than the reference value, a fourth representative map image is generated in operation S36. The fourth representative map image is generated in the same way as the second representative map image. Thus, the fourth representative map image may be generated as shown in FIG. 11.

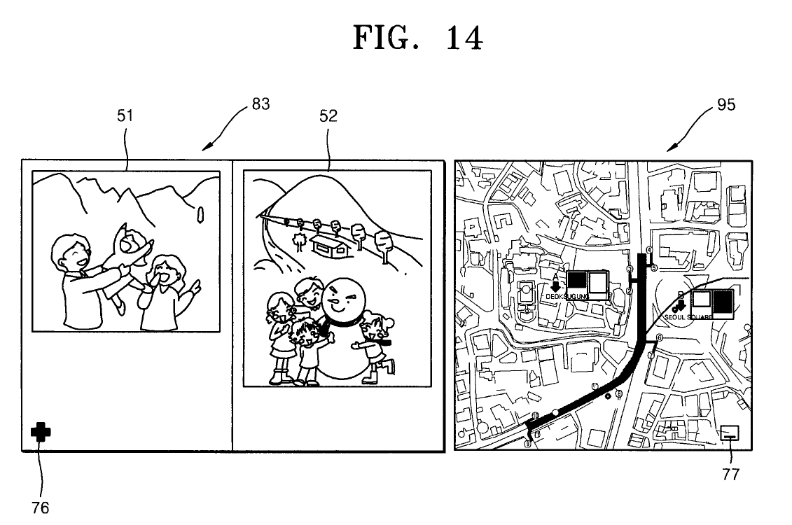

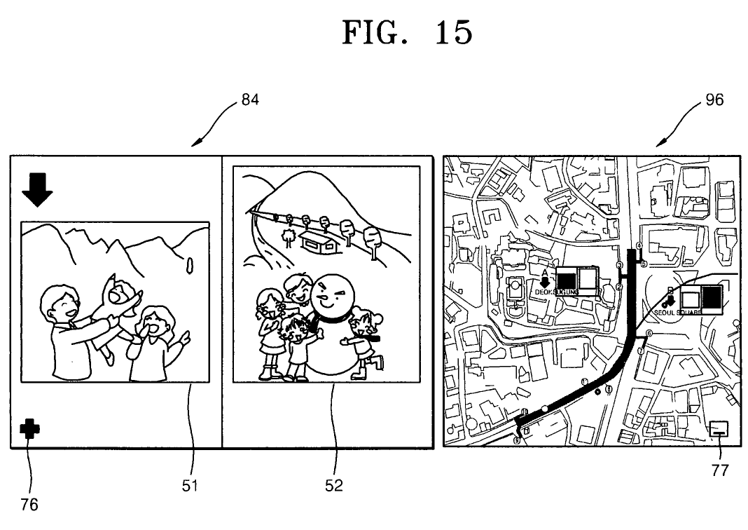

FIGS. 14 through 16 show example of a screen displaying images and map images according to the image display method of FIG. 5, wherein icons according to various embodiments of the present invention are placed at locations, which indicate where the images were captured, in the map images. As shown in FIG. 14, a first image 51 and a second image 52 are displayed on a main window 83. In addition, a cross icon 76 is displayed at a lower left corner of the main window 83 to indicate the presence of a representative map image of the first image 51 and the second image 52.

When a user selects the cross icon 76, the representative map image is displayed in a sub window 95.

In the representative map image, an icon ‘A’ is placed on ‘Deoksugung’ where the first image 51 was captured. In addition, an icon [symbol] is also placed. In this case, the icon [symbol] is a pictorial representation of the arrangements of the first image 51 and the second image 52 on screen.

In the representative map image, an icon ‘B’ is placed on ‘Seoul Square’ where the second image 52 was captured. In addition, an icon [symbol] is also placed. Thus, it can be understood from the icon [symbol] that ‘Seoul Square’ is where the second image 52 on the right side of the screen was captured. An icon 77 for closing the sub window 95 may further be displayed at a lower right corner of the representative map image.

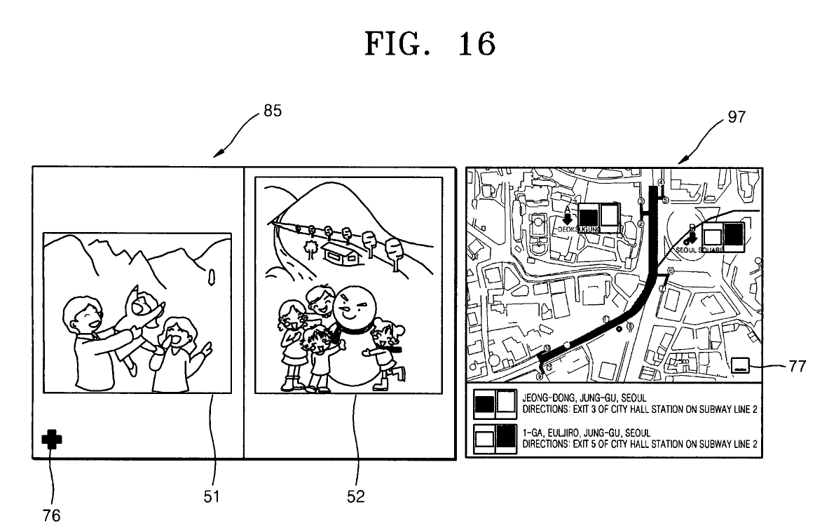

As shown in FIG. 15, when the arrangement of the first image 51 on the screen is changed, for example, when the first image 51 is placed lower than before, an icon ‘A’ and an icon [symbol] are placed on ‘Deoksugung,’ where the first image 51 was captured, in the representative map image displayed on a sub window 96. That is, an icon may be displayed to pictorially represent the changed arrangements of the first and second images 51 and 52 on the screen after the arrangement of the first image 51 on the screen is changed. Therefore, when a plurality of images and a representative map image showing locations where the images were captured are displayed together on one screen, a user can easily identify the locations, which indicate where the images were captured, by the above icons which pictorially represent the arrangements of the images on the screen.

As shown in FIG. 16, the representative image, the address of the location where each of the first and second images 51 and 52 were captured, and directions to the locations are displayed together on a sub window 97. Therefore, when a user desires to visit the locations, the user can easily find them.

As described above, the embodiments of the present invention extract map information corresponding to location information from each of a plurality of image files and displays the map information together with images contained in the image files on a terminal. Therefore, a user can easily identify locations where the images contained in the image files were captured. In addition, the present invention stores printed versions of the displayed images and map information. Therefore, even when the user views the images after a long period of time, the user can recall memories related to the images through the map information.

In particular, when displaying a plurality of images on one screen, the present invention generates a representative map image by using map images, which correspond to the images, marks locations, which indicate where the images were captured, by using signs in the representative map image, and displays the representative map image together with the images. Therefore, the user can identify a line of action formed by the locations where the images were captured and obtain additional information regarding the locations.

Furthermore, the embodiments of the present invention display icons, which pictorially represent the arrangements of the images on the screen, in the representative map image. Therefore, the user can easily identify the locations where the images were captured through the displayed icons.

While the present invention has been particularly shown and described with reference to exemplary embodiments thereof, it will be understood by those of ordinary skill in the art that various changes in form and details may be made therein without departing from the spirit and scope of the invention as defined by the following claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. An image display method comprising:
providing a plurality of image files including location information;
extracting the location information from each of the image files;
extracting map information corresponding to the location information; and
displaying images contained in the image files and the map information,
wherein the map information comprises map images of places corresponding to the location information, and a representative map image, which is determined based on a distance between the images contained in the image files and by using the map images, is displayed.

2. The method of claim 1, further comprising calculating the distance between the images in the image files.

3. The method of claim 1, further comprising printing the displayed representative map image and the displayed images of the image files.

4. The method of claim 1, wherein the map information further comprises at least one of an address of each place, a name of each place, and directions to each place.

5. The method of claim 2, further comprising:
determining whether the distance between the images contained in the image files is greater than a predetermined reference value;
generating a first representative map image, which comprises map images corresponding to the image files, when the distance between the images contained in the image files is greater than the reference value; and
selecting any one of the map images from among corresponding to the images contained in the image files as a representative map image or generating a map image configured based on at least one of locations, which indicate where the images contained in the image files were captured, in the map images and determining the generated map image as the second representative map image when the distance between the images contained in the image files is not greater than the reference value.

6. The method of claim 2, further comprising:
determining whether the distance between the images contained in the image files is greater than a predetermined reference value;
generating a third representative map image having a scale, which was changed from that of the map images to make the distance between the images contained in the image files not greater than the reference value, when the distance between the images contained in the image files is greater than the reference value; and
selecting any one of the map images from among corresponding to the images contained in the image files as a fourth representative map image or generating a map image configured based on at least one of the locations, which indicate where the images contained in the image files were captured, in the map images and determining the generated map image as the fourth representative map image when the distance between the images contained in the image files is not greater than the reference value.

7. The method of claim 1, further comprising displaying an icon at each location, which indicates where the image in each of the image files was captured, in the representative map image.

8. The method of claim 7, wherein the icon represents the arrangement of an image contained in a corresponding image file on a screen.

9. The method of claim 8, wherein, when the arrangement of the image in the corresponding image file is changed, the icon represents the changed arrangement of the image on the screen.

10. An image display method comprising:
providing a plurality of image files including location information;
extracting the location information from each of the image files;
extracting map information corresponding to the location information; and
displaying images contained in the image files, the map information and an icon at each location,
wherein the map information comprises map images of places corresponding to the location information, and a representative map image, which is determined based on a distance between the images contained in the image files and by using the map images, is displayed, and
wherein the icon indicates where the image in each of the image files was captured, in the representative map image.

11. The method of claim 10, wherein the icon represents the arrangement of an image contained in a corresponding image file on a screen.

12. An image display system comprising:
a management server which comprises a location information extracting unit which extracts location information from each of a plurality of image files, a map information extracting unit which extracts map information, which comprises map images corresponding to the extracted location information, and a representative map image determining unit which determines a representative map image using the map images from among which correspond to images contained in the image files; and
a terminal which displays the representative map image provided by the management server and the images in the image files.

13. The system of claim 12, wherein the management server further comprises a map information storage unit which stores the map information.

14. The system of claim 12, further comprising a map information providing server which provides the map information.

15. The system of claim 12, wherein the representative map image determining unit comprises:
a determination unit which determines whether a distance between the images contained in the image files is greater than a predetermined reference value; and
a generating unit which generates a first representative map image comprising at least a part of each map image when the determination unit determines that the distance between the images contained in the image files is greater than the reference value and which selects any one of the map images from among corresponding to the images contained in the image files as a second representative map image or generates a map image configured based on at least one of locations, which indicate where the images contained in the image files were captured, in the map images and determines the generated map image as the second representative map image when the distance between the images contained in the image files is not greater than the reference value.

16. The system of claim 12, wherein the representative map image determining unit comprises:
a determination unit which determines whether the distance between the images contained in the image files is greater than a predetermined reference value; and
a generating unit which generates a third representative map image having a scale changed from that of the map images to make the distance between the images contained in the image files not greater than the reference value when the distance between the images contained in the image files is greater than the reference value and which selects any one of the map images from among corresponding to the images contained in the image files as a fourth representative map image or generates a map image configured based on at least one of the locations, which indicate where the images contained in the image files were captured, in the map images and determines the generated map image as the fourth representative map image when the distance between the images contained in the image files is not greater than the reference value.

17. The system of claim 12, wherein the management server further comprises an icon generating unit which generates an icon representing an arrangement of an image contained in a corresponding image file on a screen, and the terminal displays the icon in the representative map image.

18. The system of claim 12, wherein the terminal includes a printer which displays the representative map image and the images contained in the image files and prints the displayed representative map image and the displayed images of the image files, or the image display system further comprises a printer which is separated from the terminal and is connected to the terminal to print a screen image displayed on the terminal.

19. An image display method comprising:
providing a plurality of image files respectively including location information;
extracting the location information from each of the image files;
calculating the distance between the images in the image files;
determining whether the distance between the images contained in the image files is greater than a predetermined reference value; and
displaying the images and map images of places corresponding to the location information in the image files, when the distance between the images contained in the image files is greater than the reference value.

20. An image display method comprising:
providing a plurality of image files respectively including location information;
extracting the location information from each of the image files;
calculating the distance between the images in the image files;
determining whether the distance between the images contained in the image files is greater than a predetermined reference value;
displaying the images, any one of map images of places corresponding to the location information, when the distance between the images contained in the image files is not greater than the reference value; and
displaying icons corresponding to the location information in the one of map images,
wherein the icon indicates the arrangement of an image contained in a corresponding image file on a screen.
